(19) United States
(12) Patent Application Publication
(10) Pub. No.: US 2007/0074352 A1
(43) Pub. Date: Apr. 5, 2007

(54) Method for coating leather with dispersed synthetic resin

(75) Inventor: Philip Schafer, Hannover (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/576,020

(22) PCT Filed: Oct. 16, 2004
(86) PCT No.: PCT/EP04/11689

§ 371 Date: Apr. 17, 2006

(30) Foreign Application Priority Data
Oct. 20, 2003 (AT) GM727/2003

(51) Int. Cl. C14C 1/00

(52) U.S. Cl. 8/94.15; 8/94.16

(57) ABSTRACT

In a grain leather (1) in whose grain layer (2) defects (3) formed by indentations are present, these defects are corrected by pressing an aqueous, if appropriate lightly foamed, plastics dispersion which comprises very small compact particles into these indentations by means of an application roll, as with a knife coater, and then drying the leather (1), whereupon the surface (4) of the grain layer (2) is subjected to a pressure and heat treatment at a temperature of at least 100° C. by means of a pressure roll rolling on the surface. During this procedure, a plastics compound in which hollow microspheres (5) formed from the compact particles are present and which completely fills the indentations forms in the indentations.

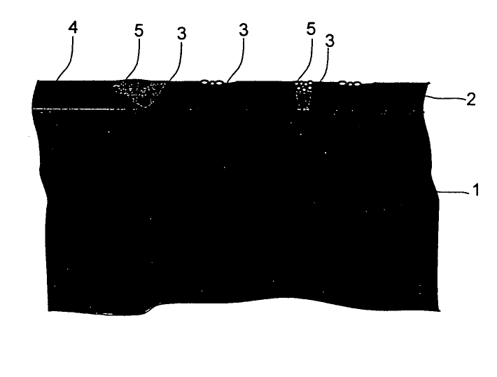

The invention relates to a process for eliminating defects in the grain layer of full-grain leather, in particular cattle leather, a plastics material eliminating the defects being applied to said defects. The invention furthermore relates to a full-grain leather, in particular cattle leather, in which the defects in the grain layer have been eliminated.

The grain layer of full-grain leather, in particular cattle leather, often has defects which have been caused, for example, by tears from hedgerows, injuries from barbed wire, insect bites or the like and which are present only in individual areas, on an area of not more than 10%, of the hide, but nevertheless reduce the value of this hide. By filling of the defects and subsequent buffing of the grain layer, such leathers are therefore converted into corrected grain leathers which, however, have a lower value and can be marketed only with a considerable discount.

It is already known that defects which do not pass through the grain layer can be filled with a plastics filling compound, the latter can be allowed to dry and the grain layer can then be buffed, the entire uppermost grain layer being removed.

It has already also been proposed, for the elimination of defects in the grain layer, to apply highly viscous, aqueous plastics filling compounds, which are foamed or comprise hollow microspheres, to the entire surface of the grain layer, to allow these filling compounds to dry and then to carry out buffing, here too the uppermost grain layer being removed. Both methods have the disadvantage that the aqueous plastics filling compounds have a solids content of not more than 80%, and these compounds therefore shrink on removal of the water, i.e. sink into the defects and become detached from the edge thereof, it being the danger that they will fall out of the defects on flexing of the leather.

It is furthermore known that a beaten foam having a high viscosity can be applied to the entire surface of the grain layer by means of rolls and can be pressed into the damaged indentations. Such beaten foams inevitably comprise a foaming agent and foam stabilizers, by means of which the water resistance of the solidified foams is reduced. In the case of full-grain leathers, a solidified beaten foam layer furthermore leads to lower adhesion of a plastics dressing subsequently applied to such a layer, because the beaten foam often splits and becomes detached from the leather.

It has also already been proposed to provide full-grain leather or leather lightly buffed on the grain side with a plastics layer which is formed from aqueous plastics dispersions which comprise compact particles and, after its solidification, is treated with a hot embossing roll or embossing plate. During this procedure, the compact particles expand and the plastics layer foams into the negative pebbled nappa structure on the surface of the hot embossing roll or embossing plate.

Thereafter, the leather is milled and is provided with a dressing. This foamed plastics layer must have a thickness such that it fills the negative pebbled nappa structure on the surface of the roll or plate so that, for this reason, a leather treated in this manner can no longer be referred to as genuine leather since the pebbled nappa effect is achieved by embossing.

It was the object of the present invention to provide a process by means of which defects in the grain layer of a full-grain leather, in particular cattle leather, can be eliminated so that the existing damage of the grain layer is no longer noticeable, but without the disadvantages of the known processes occurring, it being possible thereafter also to apply very thin dressings, so that such a leather can be referred to as genuine leather.

In particular, the process according to the invention is intended for filling the defects in the grain layer, which are formed as a rule by indentations, so that the filling compound does not fall out even in the case of continuous flexing occurring during use of the leather, that furthermore the filling compound does not shrink after its solidification, that it is water-resistant and that it in the main repairs only the defects and covers the entire surface of the grain layer only with a very small thickness, if at all.

In order to achieve this object, the invention proposes pressing an aqueous, if appropriate lightly foamed, plastics dispersion which comprises very small compact particles into the defects and then drying the leather, whereupon the grain layer is subjected to a pressure and heat treatment with the result that hollow microspheres are at least partly formed from the compact particles in the solidified plastics dispersion. Because, instead of a pasty filling compound, an aqueous plastics dispersion is instead used for filling the defects in the process according to the invention, the adhesion to the defects is substantially improved, the compact particles for the formation of the hollow microspheres expanding as a result of the pressure and heat treatment and hence an excess pressure forming so that, as a result of this, the plastics compound forming after the drying bonding at the defects to the surface of the defects and in particular to the borders of the indentations forming the defects, and withstanding any flexing. The hollow microspheres in plastics compound which is present, if appropriate, on the grain layer surface not provided with defects and which is formed from the solidified plastics dispersion are at least for the most part destroyed by the pressure and heat treatment or cannot form at all, so that at most a plastics layer whose thickness is as a rule hot measurable but in any case is less than 60 μm forms in these areas.

According to a preferred embodiment of the invention, the plastics dispersion is pressed into the defects by means of a preferably counterrotating application roll having, if appropriate, a finely structured surface, so that the plastics dispersion is applied in a very small thickness outside the defects in the manner of a coat applied by a knife coater.

The pressure and heat treatment is effected, according to the invention, by means of a pressure roll which is heated to a temperature of at least 100° C., preferably from 120° C. to 180° C., and makes contact with the grain layer and by means of which the at least partly solidified plastics dispersion is firmly pressed into the defects, and the compact particles expand for formation of the hollow microspheres in the solidified plastics dispersion.

The surface of the pressure roll may be smooth. Preferably, however, the pressure roll has a finely structured surface, as can be achieved, for example, by sand blasting, with the result that the surface of the plastics compound filling the defects also acquires such a structure.

It is particularly advantageous if compact particles having the size of less than 10 μm, preferably of less than 7 μm, are used in an amount of from 15 g to 60 g, based on 1 kg of a 40% strength plastics dispersion, and consist of a thermoplastic and comprise a liquid blowing agent. In this case, complete filling of the indentations forming the defects with the plastics compound formed from the plastics dispersion and intimate bonding thereof with the surface of the indentations are ensured.

Compact particles which expand at a temperature below 120° C., preferably below 80° C., are expediently used. At such temperatures, no pronounced three-dimensional structure is formed on the undamaged surface of the grain layer by any plastics dispersion applied there, after solidification thereof.

In a solidified plastics dispersion present in regions adjacent to the defects, troublesome hollow microspheres can be eliminated, or their formation completely prevented, if, according to the invention, a mixture of water and solvent, for example of 90 parts of water and 10 parts of solvent, in particular ethyl acetate, is applied to, preferably sprayed onto, the solidified plastics dispersion, and a pressure and heat treatment is then carried out. The hollow microspheres then present in a moist state then collapse in the presence of a small amount of solvent even at temperatures below 65° C. and at a pressure of less than 0.5 kg/cm, or they are not formed at all.

In order to adapt the appearance of the plastics compound filling the defects to that of the grain layer, pigmented compacted particles whose color corresponds to that of the grain layer and/or of the plastics dispersion are expediently used.

In a full-grain leather, in particular cattle leather, which has, on parts of its grain layer, defects which are corrected by a plastics filling compound, according to the invention the plastics filling compound consists of a solidified, aqueous plastics dispersion comprising hollow microspheres formed from compact particles by supply of heat, which plastics dispersion is pressed into the defects on application.

Preferably, the formation of the hollow microspheres in the region adjacent to the surface of the grain layer is greater than in the region more remote from the surface, which has the advantage that, after the pressure is relieved, the solidified plastics dispersion comprising hollow microspheres does not spread over the surface of the grain layer.

The only drawing shows, on a greatly enlarged scale, a full-grain leather whose defects present in the grain layer were corrected by the process according to the invention.

A leather 1, of which only the uppermost region is shown in the drawing, has a grain layer 2 which has defects 3 which have arisen through injuries to the grain layer and are formed by indentations in the grain layer 2. These indentations may pass through the entire thickness of the grain layer but may also be present only superficially on the grain layer 2. In order to eliminate the defects 3 formed by these indentations, these indentations are filled by an aqueous dispersion of any desired plastics or plastics mixtures which is very tacky in the liquid state but scarcely any longer tacky after its solidification and then has an elongation at break of more than 300%. This plastics dispersion comprises compact particles of a thermoplastic copolymer from which hollow microspheres are formed by supplying heat

The application of the aqueous plastics dispersion to the surface 4 of the grain layer 2 is effected by means of an application roll which is finely structured on its surface and by means of which the aqueous plastics dispersion is spread into the indentations as with a knife coater. Thereafter, the leather with the applied plastics dispersion is dried, and the surface 4 of the grain layer 2 is subjected to a pressure and heat treatment by means of a pressure roll heated to a temperature of from 120° C. to 180° C. The compact particles expand so that a plastics compound which comprises small hollow microspheres 5 and is pressed firmly into the indentations by the pressure exerted and bonds intimately with the border of the indentations forms in the indentations. By choosing a suitable pressure, but especially by choosing a suitable temperature of the pressure roll and the residence time thereof on the surface 4, it is ensured that the hollow microspheres form in the main only in that region of the indentations forming the defects 3 which is adjacent to the surface 4, whereas less formation takes place in the lower regions or the compact particles do not expand at all. Thus, for example with a residence time of the pressure roll of about 1 second and a roll temperature of about 145° C., hollow microspheres form only to a depth of 0.12 mm. Nevertheless, the indentations are completely filled by the solidified plastics dispersion. At a temperature of the pressure roll of more than 170° C., the residence time is halved and, owing to the heat, the formation of the hollow microspheres is then prevented in those regions where no defects 3 are present.

Furthermore, the formation of the hollow microspheres is completely prevented in a plastics dispersion applied adjacent to the indentations in the surface 4 by the applied pressure, or existing hollow microspheres are compressed in such a way that, if at all, only a plastics coating which is not troublesome and is of scarcely measurable thickness forms there and does not influence the grain layer of the leather.

Any hollow microspheres occurring in a plastics coating present in these regions can furthermore be eliminated by spraying on a mixture of about 90 parts of water and 10 parts of solvent, e.g. ethylene acetate, and then subjecting these regions to a pressure and heat treatment. In this moist state, the hollow microspheres then collapse even at temperatures below 65° C. at a pressure of less than 0.5 kg/cm², so that, in this procedure, the hollow microspheres collapse or are not formed at all.

1. A process for correcting at least one defect in a grain layer of a full-grain leather, comprising
applying an aqueous, optionally lightly foamed, plastics dispersion comprising small compact particles into the at least one defect,
drying the leather, thereby forming a solidified plastics dispersion, and
subjecting the leather to a pressure and heat treatment,
with the result that hollow microspheres are at least partially formed from the small compact particles in the solidified plastics dispersion, and the at least one defect is thereby corrected.

2. The process of claim 1, wherein the full-grain leather is cattle leather.

3. The process of claim 1, wherein the applying comprises pressing the aqueous plastics dispersion into the at least one defect with an application roll having, optionally, a finely structured surface.

4. The process of claim 3, wherein the application roll is a counterrotating application roll.

5. The process of claim 1, wherein the pressure and temperature treatment is effected using a pressure roll which is heated to a temperature of at least 100° C. and makes contact with the grain layer.

6. The process of claim 5, wherein the pressure roll is heated to a temperature from 120° C. to 180° C.

7. The process of claim 5, wherein the pressure roll has a finely structured surface.

8. The process of claim 1, wherein the compact particles have a size of less than 10 μm are used in an amount of from 15 g to 60 g, based on 1 kg of a 40% strength aqueous plastics dispersion.

9. The process of claim 1, wherein compact particles comprise a thermoplastic, which comprises a liquid blowing agent.

10. The process of claim 1, wherein the compact particles expand at a temperature below 120° C.

11. The process of claim 1, wherein the applying, drying, and subjecting are further carried out on at least one region adjacent to the at least one defect, thereby forming a solidified plastics dispersion comprising hollow microspheres on the at least one region, and wherein, after formation of the solidified plastics dispersion comprising hollow microspheres on the at least one region, a mixture of water and a solvent is applied to the at least one region and a pressure and heat treatment is then effected.

12. The process of claim 11, wherein the applying comprises spraying the mixture of water and a solvent onto the solidified plastics dispersion comprising hollow microspheres on the at least one region.

13. The process of claim 11, wherein the solvent is ethyl acetate.

14. The process of claim 11, wherein the mixture comprises 90 parts of water and 10 parts of solvent.

15. The process of claim 1, wherein the small compact particles comprise pigmented compact particles whose color corresponds to that of the grain layer, the plastics dispersion, or a combination thereof.

16. A full-grain leather, which comprises, on its grain layer, at least one defect which has been corrected by applying a plastics filling compound to the at least one defect, wherein the plastics filling compound comprises a solidified, aqueous plastics dispersion which comprises hollow microspheres formed from compact particles by supplying heat and is pressed into the at least one defect on application.

17. The full-grain leather according to claim 16, which is cattle leather.

18. The full-grain leather of claim 16, wherein the formation of the hollow microspheres in the region adjacent to the to the at least one defect on the surface of the grain layer is greater than on the surface of the grain layer further away from the at least one defect.

19. The process of claim 1, wherein the aqueous plastics dispersion is lightly foamed.

20. The process of claim 3, wherein the application roll has a finely structured surface.
